(19) United States
(12) Patent Application Publication
(10) Pub. No.: US 2010/0204351 A1
(43) Pub. Date: Aug. 12, 2010

(54) PHENOLIC NOVOLAC FOAMS AND COMPOSITIONS FOR PREPARING THEM

(76) Inventors: Raymond J. Swedo, Mount Prospect, IL (US); G. David Green, Cary, IL (US); Francois M. Casati, Pfaffikon (CH)

Correspondence Address: The Dow Chemical Company, P.O. BOX 1967, Midland, MI, 48641, US

(21) Appl. No.: 12/677,326

(22) PCT Filed: Sep. 17, 2008
(86) PCT No.: PCT/US08/76591

§ 371 Date: Mar. 10, 2010

Related U.S. Application Data
(60) Provisional application No. 60/978,200, filed on Oct. 8, 2007.

(51) Int. Cl. C08G 8/10; C08K 5/353; C08J 9/14

(52) U.S. Cl. 521/79; 521/90; 521/88; 521/181

(57) ABSTRACT

A foamable novolac phenolic resin composition suitable for preparing phenolic foams that are free of corrosive acid catalysts and excess aldehydes. The composition comprises a novolac resin, an oxazolidine hardener, and a blowing agent.

### FIELD OF THE INVENTION

The invention relates to foamable novolac resin compositions useful for preparing phenolic novolac foams.

### BACKGROUND OF THE INVENTION

Phenolic resins can be broadly divided into two general classes: novolacs and resoles. Novolac resins are generally characterized as being formaldehyde deficient. That is to say that the ratio of formaldehyde to phenolic groups is <1. Resole resins are generally characterized as being formaldehyde rich. That is to say that the ratio of formaldehyde to phenolic groups is >1. Both novolacs and resoles may incorporate a variety of phenolic compounds, including but not limited to phenol, resorcinol, bisphenols, phloroglucinol, cresols, alkyl phenols, phenyl ethers, tannins, and lignins. Similarly, other aldehydes may be substituted in whole or in part for formaldehyde, including but not limited to acetaldehyde, propionaldehyde, cyclohexanedicarboxaldehydes, benzaldehydes, furfural, and other aryl heterocyclic aldehydes.

Novolac resins are usually cured (crosslinked, hardened) through the use of an aldehyde donor such as formaldehyde or formaldehyde polymers such as dioxolane, trioxane, and paraformaldehyde, hexamethylenetetramine (hexa), or even a resole resin. In addition to an aldehyde source, heating and the presence of a catalyst are usually employed to accelerate the rate and extent of curing. Catalysts may include inorganic bases such as sodium, potassium, or calcium hydroxide, Lewis acids such as zinc chloride or zinc acetate, or amines such as triethylamine.

In contrast to novolac resins, resoles are formaldehyde rich and do not require the addition of an aldehyde source in order to effect curing. Resole resins are cured by heating either alone or, more typically, in the presence of an acid catalyst.

Foams generated from phenolic resins are well known and provide a number of advantages over foams generated from polyurethanes. For example, polyurethane foams are not useful in high temperature environments and, when burned, generate smoke and fumes. In contrast, foams generated from phenolic resins are useful in high temperature environments and do not generate fumes when burned. Thus, foams generated from phenolic resins are useful as thermal insulating material for hot or cold pipes, freezers and cold rooms, HVAC equipment, chemical tanks, aircraft, trains, marine applications, roofs, and buildings and mobile homes or in acoustic applications.

Phenolic foams may be generated from either resole or novolac resins. Commercial phenolic foams generated from resole resins are advantageous to use because they can be cured at low temperatures. However, this low curing temperature is achieved through the use of acid catalysts which remain in the cured foam and lead to metal corrosion problems.

Commercial phenolic foams generated from novolac resins are advantageous in that they do not use acid catalysts to effect their curing. However, the hardeners needed to effect cure lead to emissions of formaldehyde and/or ammonia. These by-products, trapped in the foam, slowly diffuse out and potentially lead to environmental issues.

A need exists, therefore, for phenolic foams that overcome the problems of the prior art; namely, metal corrosion caused by the presence of metal catalysts, and/or the off-gassing of formaldehyde. The foams of the invention address this need.

### BRIEF SUMMARY OF THE INVENTION

In one aspect, the invention provides a phenolic foam composition useful for forming a phenolic foam. The composition comprises: a novolac resin; an oxazolidine hardener; and a blowing agent. The composition is preferably substantially free of free aldehydes. The composition is also preferably substantially free of acid catalysts.

In another aspect, the invention provides a phenolic foam that is the reaction product of the foamable compositions described herein.

In a further aspect, the invention provides methods for manufacturing phenolic foams.

### DETAILED DESCRIPTION OF THE INVENTION

The invention provides phenolic foam compositions that generate phenolic novolac foams without the use of acidic catalysts or formaldehyde-based hardeners. The use of non-formaldehyde hardeners according to the invention enables the preparation of novolac foams without generating formaldehyde emissions. The non-formaldehyde hardeners used herein are not acidic. Consequently, metal corrosion due to acidic catalysts, which is one of the main drawbacks to current phenolic foams, is not a concern with the foams of the invention. The phenolic foams of the inventions can be used in a variety of applications including, but not limited to, as insulating materials for hot or cold pipes, freezers and cold rooms, HVAC equipment, chemical tanks, aircraft, trains, marine applications, roofs, and buildings and mobile homes.

In one aspect, therefore, the invention provides a phenolic foam composition useful for generating phenolic foams. The composition comprises a novolac resin, an oxazolidine hardener, and a blowing agent. The composition may include other optional components including a surfactant, a nucleating agent, solvents, tougheners, plasticizers, and other additives familiar to those skilled in the art.

The phenolic novolac resin preferred for use in the invention has a weight average molecular weight of about 1000 or less. In practice, the choice of novolac resin molecular weight is limited only by its ability to exist as a solution or melt under the conditions of foam generation.

The preparation of novolac resins is well known to those skilled in the art, and commercial novolacs are widely available. Typically, the novolac resin is prepared by the reaction of a phenolic compound and an aldehyde. The phenolic compound is preferably phenol, resorcinol, bisphenol, phloroglucinol, cresols, alkyl phenols, phenol ethers, tannins or lignins. Phenol is particularly preferred. The aldehyde is preferably selected from formaldehyde, acetaldehyde, propionaldehyde, cyclohexanedicarboxaldehydes, benzaldehydes, furfural, an aryl aldehyde, a heterocyclic aldehyde, and mixtures of two or more thereof. Formaldehyde is a particularly preferred aldehyde. The ratio of aldehyde to phenolic compound in the resin is less than one.

Blowing agents used for the generation of phenolic foams are commonly selected from the following classes of compounds: water, fluorocarbons such as 2,3-dihydrodecafluoropentane, 1,1,1,3,3-pentafluoropropane, perfluorohexane, perfluoro-N-morpholine, or pentafluorotoluene, chlorofluorocarbons such as 1,1,2-trichloro-1,2,2-trifluoroethane, hydrogenated chlorofluorocarbons such as 1,3-dichloro-1,1,2,2,3-pentafluoropropane, linear, branched, or cyclic alkanes such as n-pentane, isobutane, or cyclopentane, aromatic hydrocarbons such as toluene, ethylbenzene, or xylenes, alcohols such as t-amyl alcohol, isoamyl alcohol, or n-hexanol, and fluorinated alcohols such as 2,2,3,3,4,4,4-heptafluoro-1-butanol or 2,2,3,3,4,4,5,5-octafluoro-1-pentanol. They may be used alone or in combination. The blowing agents in the invention have boiling points not more than about 100° C. lower than the temperature at which foam is to be generated. More preferably, the boiling points of the blowing agents are not more than about 50° C. lower than the temperature at which the foam is to be generated. Typically, the ratio of blowing agent to novolac resin in the foam composition (i.e., weight of blowing agent divided by weight of novolac resin) is between about 5 and 25 weight percent, more preferably between about 10 and 20 weight percent.

In order to control foam expansion, vacuum or increased atmospheric pressure can be used in addition to auxiliary blowing agents. Chemical blowing is also contemplated, such as reaction of water and isocyanate, for instance.

The oxazolidine hardeners used in this invention are preferably chosen from compounds having the following structures:

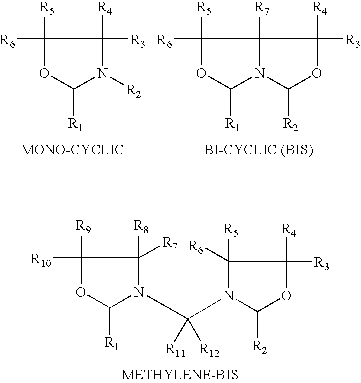

Where R₁, R₂, R₃, R₄, R₅, and R₆ for the mono-cyclic oxazolidines may be the same or different and are selected from H, C₁-C₁₂ linear or branched alkyl or alkenyl, cycloalkyl, phenyl, substituted aryl, heterocyclic, hydroxymethyl, hydroxy-terminated polyoxyalkylene, and halogen. Where R₁, R₂, R₃, R₄, R₅, R₆, and R₇ for the bi-cyclic oxazolidines may be the same or different and are selected from H, C₁-C₁₂ linear or branched alkyl or alkenyl, cycloalkyl, phenyl, substituted aryl, heterocyclic, hydroxymethyl, hydroxy-terminated polyoxyalkylene, and halogen. Where R₁, R₂, R₃, R₄, R₅, R₆, R₇, R₈, R₉, R₁₀, R₁₁, and R₁₂ for the methylene-bis-oxazolidines may be the same or different and are selected from H, C₁-C₁₂ linear or branched alkyl or alkenyl, cycloalkyl, phenyl, substituted aryl, heterocyclic, hydroxymethyl, hydroxy-terminated polyoxyalkylene, and halogen.

Particularly preferred oxazolidines include 4,4-dimethyl-1-oxa-3-azacyclopentane (AMINE CS-1135®), 5-hydroxymethyl-1-aza-3,7-dioxabicyclo[3.3.0]octane (LH-1000), and 5-ethyl-1-aza-3,7-dioxabicyclo[3.3.0]octane (LH-2000).

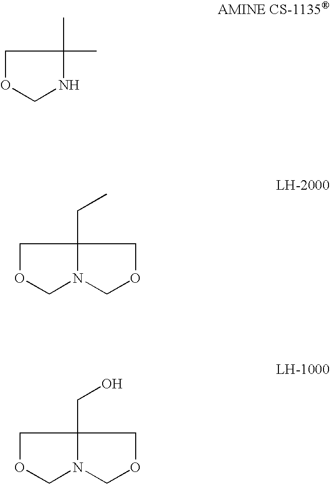

Typically, the ratio of oxazolidine to novolac resin in the foam composition of the inventions is between about 40 and 50 weight percent, more preferably between about 42 and 48 weight percent.

In preferred embodiments, the foam composition includes one or more surfactants. Suitable surfactants are commonly selected from the following classes of compounds: dimethylsiloxanes, polyalkyleneoxide siloxanes, polyalkyleneoxide dimethylsiloxane copolymers, alkoxylated alkyl phenols, alkoxylated alcohols, alkylated polyglucosides, alkoxylated alcohol phosphate esters, alkoxylated alcohol sulfate esters, alkoxylated alcohol sulfonate esters, alkoxylated cellulose, alkoxylated seed oil derivatives, such as castor oil, and ethylene oxide/propylene oxide or butylene oxide copolymers. They may be used alone or in combination. The surfactants preferred for this invention are the dimethylsiloxanes, polyalkyleneoxide siloxanes, and polyalkyleneoxide dimethylsiloxane copolymers. When surfactant is used, the typical ratio of surfactant to novolac resin is between about 2.5 and 10 weight percent.

In further preferred embodiments, the foam composition of the invention includes one or more nucleating agents. Preferred nucleating agents are selected from among the various solid materials commonly used as inert fillers, including minerals such as silica, alumina, talc, calcium carbonate, wollastonite, silimanite, and various clays; glass; cellulose; carbon; graphite; and polymers. They may be used alone or in combination.

Important considerations for nucleating agents are that they be of small particle size (<0.5 mm, and preferably, <0.1 mm) and are not reactive with other formulation components. The nucleating agents preferred for this invention are carbon, graphite, and clays. Typical loadings of the nucleating agent relative to the novolac resin are as follows: between about 5 and 10 weight percent.

The compositions of the invention can contain other ingredients typically used with foam formulations, including crosslinkers such as epoxy resins, plastizers such as polyesters, pigments, urea and/or resorcinol derivatives, catalysts, etc.

The phenolic foam of the invention has an overall density between 10 and 400 kg/m³, preferably between 15 and 200 kg/m³, more preferably between 20 and 100 kg/m³. Percentage of closed cells is at least 10 percent and average cell size is below 1 mm in diameter, more preferably below 0.5 mm.

The foam compositions of the invention are used for generating foams, which have a variety of uses, including as insulating materials for hot or cold pipes, freezers and cold rooms, HVAC equipment, chemical tanks, aircraft, trains, marine applications, roofs, and buildings and mobile homes. As noted earlier, one of the advantages of the foams of the invention is that they can be prepared to be substantially free of free aldehydes. By “substantially free” of free aldehydes, it is meant that the foam contains less than 3 percent by weight of free aldehydes, more preferably less than 1 percent, even more preferably less than 0.5 percent. Most preferably, the foam contains no free aldehydes.

A further advantage of the foams of the invention is that they can be prepared to be substantially free of acid catalysts which, as noted above, can cause corrosion and/or generate VOC's. By substantially free of acid catalysts, it is meant that the foams contain less than about 1 percent by weight of acid catalyst, more preferably less than 0.5 weight percent. Most preferably, the foams contain no acid catalysts.

A general procedure for forming a foam from the composition of the invention is as follows. All components (novolac resin, hardener, blowing agents, foam stabilizers and any other optional additives) are mixed using a high speed mixer, preferably using a low pressure mixing chamber with components being metered via dosing pumps. Then the foam can be produced either continuously or discontinuously.

With the continuous process the foamable phenolic resin composition is discharged onto a continuously running carrier, using for instance a moving arm or several mix-heads to get proper material distribution, passed through a heated zone (curing oven) while the top surface of the rising foam is pressed down with a second conveyor to a predetermined thickness. Such rigid panels are usually sandwiches, i.e., covered with facing materials either fibrous, organic, inorganic, or metallic, plastic foils or sheets, with or without suitable primer coating to enhance adhesion. Pipe insulation covers can also be produced continuously but with a round moving band, instead of a flat conveyor. Continuous foam blocks of various heights can also be continuously produced for subsequent slicing to proper thicknesses. Pultrusion techniques using an extruder can also be used.

With discontinuous processes the reactants are poured in a heated mold, eventually pretreated with a proper release agent, which is closed before the foaming mass fills it. Air escapes through proper venting. Inserts or facings can be used with the molding process as well. Once the foam is cured, the mold is opened, emptied of the foam and refilled with new reactants. Such molds can be moved by a conveyor going through a curing oven. Various mold shapes can be prepared depending on the application, including buns, panels, pipe covers, etc. With in situ processes the reaction mixture is applied with an appropriate distribution system onto the surface to be treated.

The following examples are illustrative of the invention but are not intended to limit its scope.

### Examples

Ethanol, n-hexanol, pentane, montmorillonite KSF, triazine, and hexamethylenetetramine (hexa) are obtained from Aldrich. The phenolics resin used in these examples are a solvent-free, partially neutralized novolac having a weight average molecular weight of about 600, obtained from Plastics Engineering Company (Sheboygan, Wis., USA). To facilitate formulation, master batches of novolac resin dissolved in either ethanol or n-hexanol are prepared.

The oxazolidines 4,4-dimethyl-1-oxa-3-azacyclopentane (AMINE CS-1135®) and 5-ethyl-1-aza-3,7-dioxabicyclo[3.3.0]octane (AMINE CS-1246™) are obtained from ANGUS Chemical Company.

The blowing agent 2,3-dihydrodecafluoropentane (Vertrel XF, HFC-43-10mee) is obtained from DuPont.

The dimethylsiloxane (Niax SR355) and polyalkyleneoxide siloxane (Niax L-6915) compounds are obtained from GE Silicones. The ethoxylated octylphenol (Triton X-100) is obtained from the Dow Chemical Company. The ethoxylated nonylphenol (Igepal CO-887) is obtained from Rhodia. The hydroxyethyl cellulose (Natrosol 250H4BPRA) is obtained from Hercules. The carbon (Norit S51) is obtained from Norit Americas, Inc. The calcium carbonate (Supermite) is obtained from Imerys. The talc (Nicron 674) is obtained from Luzenac America. The Tech Lube 250CP is obtained from Technick Products. The fluorocarbon spray (MS-122) is obtained from Miller-Stephenson.

### General Procedure:

Four resin master batches are prepared to facilitate formulation. The first master batch contains 77.9 wt. % novolac resin, 4.2 wt. % Niax SR355, and 17.9 wt. % ethanol. The second master batch contains 84.7 wt. % novolac resin, 4.6 wt. % Niax SR355, and 10.7 wt. % n-hexanol. The third master batch contains 84.5 wt. % novolac resin, 4.8 wt. % Niax SR355, and 10.7 wt. % n-hexanol. The fourth master batch contains 94.8 wt. % novolac resin and 5.2 wt. % Niax SR355.

For each example, a mold is prepared by lining a 600 mL stainless steel beaker with aluminum foil. The inside of the foil is sprayed with MS-122 fluorocarbon to facilitate removal of the foam.

The foam formulation compositions prepared in these examples vary depending upon whether or not a nucleating agent is included, and whether the solvent is also the blowing agent. Four broad formulation compositions are represented in Table 1:

TABLE 1

| | COMPOSITION, WT. % | | | | | | | |
|---|---|---|---|---|---|---|---|---|
| COMPONENT | A | | B | | C | | D | |
| NOVOLAC | | 51.8 | | 50.1 | | 61.9 | | 58.4 |
| RESIN | | | | | | | | |
| SOLVENT | ethanol | 12.2 | ethanol | 11.1 | | | | |
| HARDENER | | 22.9 | | 21.9 | | 26.7 | | 25.7 |
| BLOWING | Vertrel | 10.4 | Vertrel | 9.9 | n- | 7.8 | n-hexanol | 7.4 |
| AGENT | XF | | XF | | hexanol | | | |
| SURFACTANT | | 2.7 | | 2.6 | | 3.5 | | 3.3 |
| NUCLEATING | | | | 4.4 | | | | 5.1 |
| AGENT | | | | | | | | |

The desired amounts of resin master batch, hardener, blowing agent, surfactant, and nucleating agent are weighed into a tared paper cup. The formulation is mixed well using a high speed stirrer, and the weight of the cup with formulation is determined. The formulation is poured into a prepared mold, then the cup is re-weighed to determine the amount of formulation transferred to the mold. The mold is covered with a large watch glass, then it is placed into an air-circulating oven that is pre-heated to the desired foam test temperature. After the desired foam generating time has elapsed, the mold with generated foam is cooled back to 50° C. over 15 minutes.

The foam is removed from the mold, and the aluminum foil is peeled off. The maximum foam height is measured, then the sample is cut in half lengthwise, and the size and distribution of the cells is determined. A rectangular solid piece is cut from the sample, it is weighed, and its dimensions are measured using a micrometer. The density of the piece is then calculated from the weight and calculated volume.

The results of the foam generation tests are summarized in the Table below.

The results presented in the Table clearly illustrate that phenolic novolac foams can be generated using oxazolidine hardeners under a variety of conditions. The choice of solvent, surfactant, blowing agent, and foaming temperature are important factors affecting foam quality.

Examples 3, 4, and 5 show that at temperatures of ≦110° C. the rate of resin curing is too slow to effectively trap the blowing agent before it is volatilized. In contrast, Examples 2, 6, and 10 show that good foams are generated at temperatures as low as 150° C. and as high as 200° C.

Examples 8 and 20 show that increasing the amount of blowing agent results in a higher column of foam being generated. However, Example 21 shows that if the solvent is removed, the use of a large amount of resin-insoluble blowing agent will not effectively generate foam. In contrast, Examples 30 and 35 demonstrate that the resin solvent can also act as the blowing agent. The relatively high boiling point of the n-hexanol (only ca. 20° C. lower that the foam generation temperature) allows resin curing to occur before too much solvent is blown off.

Foam columns ≧10 cm in height are generated from formulations with (Examples 13, 20, 30, and 35) and without nucleating agents (Examples 6 and 7). Calcium carbonate (Supermite, Examples 9, 14, and 32-34) and talc (Nicron 674, Example 18) produce shorter foam column than does clay (Montmorillonite KSF, Example 12) and carbon (Norit S51, Examples 13, 30, and 35). Although calcium carbonate does not produce the highest foam columns, it is effective in yielding foam having a smaller and more uniform cell size.

For surfactants, favorable results are obtained with dimethylsiloxane (Niax SR355) and polyalkyleneoxide siloxane (Niax L-6915) (Examples 6, 7, 13, 20, 30, and 35). The use of the ethoxylated octylphenol (Triton X-100), the ethoxylated nonylphenol (Igepal CO-887), and the hydroxyethyl cellulose (Natrosol 250H4BPRA) results in significantly shorter foam columns.

The examples illustrate that useful phenolic novolac foams can be generated using unique oxazolidine hardeners.

While the invention has been described above according to its preferred embodiments, it can be modified within the spirit and scope of this disclosure. This application is therefore intended to cover any variations, uses, or adaptations of the invention using the general principles disclosed herein. Further, the application is intended to cover such departures from the present disclosure as come within the known or customary practice in the art to which this invention pertains and which fall within the limits of the following claims.

TABLE OF RESULTS

| | EXAMPLE # | | | | | | | | | | |
|---|---|---|---|---|---|---|---|---|---|---|---|
| | 1 | 2 | 3 | 4 | 5 | 6 | 7 | 8 | 9 | 10 | 11 |
| Resin, g | 16.99 | 17.01 | 17.00 | 17.03 | 8.58 | 17.22 | 17.18 | 17.15 | 17.11 | 17.16 | 17.31 |
| Ethanol, g | 3.99 | 3.99 | 3.99 | 3.99 | 1.92 | 3.85 | 3.83 | 3.83 | 3.82 | 3.83 | 3.80 |
| Hardener | | | | | | | | | | | |
| ZE, g | 7.50 | 7.52 | 7.49 | | | 7.53 | 7.49 | 7.52 | 7.54 | 7.50 | 7.50 |
| CS1135, g | | | | 13.95 | | | | | | | |
| Triazine, g | | | | | 3.00 | | | | | | |
| Blowing Agent | | | | | | | | | | | |
| Vertrel XF, g | 3.40 | 3.39 | 3.42 | 3.43 | | 3.39 | 3.40 | 3.41 | 3.40 | 3.40 | 3.38 |
| Pentane, g | | | | | 1.70 | | | | | | |
| Surfactant | | | | | | | | | | | |
| Niax SR355, g | 0.92 | 0.92 | 0.92 | 0.92 | 0.47 | 0.94 | 0.94 | 0.94 | 0.93 | 0.94 | |
| Triton X-100, g | | | | | | | | | | | |
| Igepal CO-887, g | | | | | | | | | | | |
| Natrosol 250H4BPRA, g | | | | | | | | | | | |
| Nucleating Agent | | | | | | | | | | | |
| Supermite (CaCO3), g | | | | | | | | | 1.47 | | |
| Norit S51 (carbon), g | | | | | | | | | | | |
| Montmorillonite KSF (clay), g | | | | | | | | | | | |
| Nicron 674 (talc), g | | | | | | | | | | | |
| Mold Release | | | | | | | | | | | |
| Tech Lube 250 CP, g | | | | | 0.22 | 0.22 | 0.21 | | | | |
| Total Wt., g | 32.80 | 32.83 | 32.82 | 39.32 | 15.89 | 33.15 | 33.05 | 32.88 | 34.28 | 32.83 | 31.99 |
| Transferred Wt., g | | | | | 13.10 | 29.53 | 29.68 | 29.24 | 31.07 | 30.04 | 28.89 |
| Temperature, ° C. | 110.00 | 150.00 | 100.00 | 80-100 | 60-110 | 175.00 | 175.00 | 175.00 | 175.00 | 200.00 | 175.00 |
| Time, hours | 4.00 | 1.00 | 21.00 | 3.00 | 6.00 | 0.50 | 0.50 | 0.50 | 0.50 | 0.25 | 0.50 |
| Covered Mold | no | no | no | no | no | no | yes | yes | yes | yes | yes |
| Foam | | | | | | | | | | | |
| Maximum Height, cm | 7.50 | 9.50 | 0.40 | 2.00 | 1.75 | 10.00 | 10.00 | 9.50 | 8.00 | 9.50 | 3.00 |
| Maximum Diameter, cm | 7.50 | 7.50 | 8.00 | 7.50 | 5.50 | 7.50 | 7.50 | 7.50 | 7.50 | 7.50 | 7.50 |
| Cell Structure | | | | | | | | | | | |
| uniform | no | yes | no | no | no | no | no | no | no | no | no |
| average cell size, mm | <1 to >5 | 2 to 5 | | | | 2 to >10 | 2 to 4 | 1 to 3 | 1 to >5 | <1 to 5 | 3 to 5 |
| Sample Density, kg/m³ | | 41.3 | | | | | | 51 | | 44.5 | |

| | EXAMPLE # | | | | | | | |
|---|---|---|---|---|---|---|---|---|
| | 12 | 13 | 14 | 15 | 16 | 17 | 18 | 19 |
| Resin, g | 17.14 | 17.28 | 17.13 | 25.09 | 25.09 | 25.17 | 17.13 | 17.14 |
| Ethanol, g | 3.83 | 3.86 | 3.82 | 5.51 | 5.51 | 5.53 | 3.82 | 3.83 |
| Hardener | | | | | | | | |
| ZE, g | 7.49 | 7.50 | 7.51 | 10.96 | 10.95 | 10.99 | 7.54 | 7.50 |
| CS1135, g | | | | | | | | |
| Triazine, g | | | | | | | | |
| Blowing Agent | | | | | | | | |
| Vertrel XF, g | 3.44 | 3.41 | 3.38 | 5.22 | 4.97 | 4.97 | 3.41 | 3.41 |
| Pentane, g | | | | | | | | |
| Surfactant | | | | | | | | |
| Niax SR355, g | 0.94 | 0.94 | 0.94 | | | | 0.93 | 0.94 |
| Triton X-100, g | | | | | 1.43 | | | |
| Igepal CO-887, g | | | | | | 1.42 | | |
| Natrosol 250H4BPRA, g | | | | 1.43 | | | | |
| Nucleating Agent | | | | | | | | |
| Supermite (CaCO3), g | | | 1.47 | | | | | |
| Norit S51 (carbon), g | | 1.48 | | 2.15 | 2.12 | 2.20 | | 1.48 |
| Montmorillonite KSF (clay), g | 1.49 | | | | | | | |
| Nicron 674 (talc), g | | | | | | | 1.48 | |
| Mold Release | | | | | | | | |
| Tech Lube 250 CP, g | | | | | | | | |
| Total Wt., g | 34.32 | 34.47 | 34.25 | 50.36 | 50.07 | 50.28 | 34.32 | 34.29 |
| Transferred Wt., g | 32.28 | 32.00 | 31.19 | 45.56 | 46.04 | 46.11 | 31.01 | 31.61 |
| Temperature, ° C. | 175.00 | 175.00 | 175.00 | 175.00 | 175.00 | 175.00 | 175.00 | 150.00 |
| Time, hours | 0.50 | 0.50 | 0.50 | 0.50 | 0.50 | 0.50 | 0.50 | 1.00 |
| Covered Mold | yes | yes | yes | yes | yes | yes | yes | yes |
| Foam | | | | | | | | |
| Maximum Height, cm | 9.50 | 10.20 | 9.00 | 4.00 | 3.50 | 3.50 | 8.70 | 8.00 |
| Maximum Diameter, cm | 7.50 | 7.50 | 7.50 | 7.50 | 7.50 | 7.50 | 7.50 | 7.50 |
| Cell Structure | | | | | | | | |
| uniform | no | yes | no | no | no | no | no | no |
| average cell size, mm | 1 to 5 | ca. 1 | <1 to >5 | <1 to >10 | <1 to >5 | <1 to >10 | <1 to >10 | 1 to >10 |
| Sample Density, kg/m³ | | 47.7 | 53.7 | | | | | |

| | EXAMPLE # | | | | | | | |
|---|---|---|---|---|---|---|---|---|
| | 20 | 21 | 22 | 23 | 24 | 25 | 26 | 27 |
| Resin, g | 53.33 | 42.52 | 46.87 | 46.87 | 17.16 | 17.16 | 17.15 | 17.12 |
| Ethanol, g | | | | | | | 3.83 | 3.82 |
| Hardener | | | | | | | | |
| ZE, g | 24.63 | 19.61 | 21.66 | 21.66 | 7.55 | 7.55 | 7 | 7 |
| CS1135, g | | | | | | | | |
| Triazine, g | | | | | | | | |
| Hexamethylenetetramine, g | | | | | | | 0.5 | 0.5 |
| Blowing Agent | | | | | | | | |
| Vertrel XF, g | 11.19 | 8.90 | 9.82 | 9.82 | | | 3.39 | 3.4 |
| Pentane, g | | | | | | | | |
| n-Hexanol, g | | | | | 2.17 | 2.17 | | |
| Surfactant | | | | | | | | |
| Niax SR355, g | 2.93 | 2.33 | 2.57 | 2.57 | 0.93 | 0.93 | 0.94 | 0.93 |
| Triton X-100, g | | | | | | | | |
| Igepal CO-887, g | | | | | | | | |
| Natrosol 250H4BPRA, g | | | | | | | | |
| Nucleating Agent | | | | | | | | |
| Supermite (CaCO3), g | | | | | | | | |
| Norit S51 (carbon), g | | | | | | | | |
| Montmorillonite KSF (clay), g | | | | | | | | |
| Nicron 674 (talc), g | | | | | | | | |
| Mold Release | | | | | | | | |
| Tech Lube 250 CP, g | | | | | | | | |
| Total Wt., g | 92.07 | 73.36 | 80.92 | 80.92 | 27.78 | 27.83 | 32.81 | 32.79 |
| Transferred Wt., g | 65.40 | 28.34 | 24.30 | 24.92 | 23.5 | 21.59 | 25.63 | 27.06 |
| Temperature, ° C. | 175.00 | 175.00 | 175.00 | 150 | 175 | 200 | 175 | 150 |
| Time, hours | 0.50 | 0.50 | 0.50 | 1 | 0.5 | 0.25 | 0.5 | 0.75 |
| Covered Mold | yes | yes | yes | yes | yes | yes | yes | yes |
| Foam | | | | | | | | |
| Maximum Height, cm | 10.80 | 3.70 | 4.80 | 4 | 7.7 | 6.2 | 9.8 | 8.9 |
| Maximum Diameter, cm | 7.50 | 7.50 | 7.50 | 7.5 | 7.5 | 7.5 | 7.5 | 7.5 |
| Cell Structure | | | | | | | | |
| uniform | no | no | no | fairly | fairly | fairly | no | no |
| average cell size, mm | <2 to >10 | <<1 to 10 | <<1 to >5 | 1 to >10 | 1 to 5-10 | 1-2 to 5-10 | <2 to >10 | >2 |
| Sample Density, kg/m³ | 141.7 | 196 | 212 | 279.5 | 65.8 | 86.6 | 37.6 | 41.6 |

| | EXAMPLE # | | | | | | | | |
|---|---|---|---|---|---|---|---|---|---|
| | 28 | 29 | 30 | 31 | 32 | 33 | 34 | 35 | 36 |
| Resin, g | 17.16 | 17.07 | 17.68 | 17.53 | 18.13 | 17.1 | 17.09 | 17.63 | 17.68 |
| Ethanol, g | | | | | | | | | |
| Hardener | | | | | | | | | |
| ZE, g | 7.1 | 7.56 | 7.1 | 7.56 | 7.51 | 7.53 | 7.12 | 7.1 | 7.13 |
| Hexamethylenetetramine, g | 0.51 | | 0.49 | | | | 0.5 | 0.5 | 0.5 |
| Blowing Agent | | | | | | | | | |
| Vertrel XF, g | | | | | | | | | |
| n-Hexanol, g | 2.17 | 2.16 | 2.24 | 2.22 | 2.3 | 2.17 | 2.16 | 2.23 | 2.24 |
| Surfactant | | | | | | | | | |
| Niax SR355, g | 0.93 | | | | 0.99 | | | 0.96 | |
| Niax L6915, g | | 0.97 | 1.01 | 1 | | 0.97 | 0.97 | | 1.01 |
| Nucleating Agent | | | | | | | | | |
| Supermite (CaCO3), g | | | | | 1.48 | 1.5 | 1.48 | | |
| Norit S51 (carbon), g | 1.48 | | 1.46 | | | | | 1.48 | 3.08 |
| Total Wt., g | 29.37 | 27.76 | 29.98 | 28.31 | 30.4 | 29.27 | 29.33 | 29.91 | 31.64 |
| Transferred Wt., g | 22.35 | 23.71 | 25.73 | 23.44 | 23.52 | 24.35 | 25.51 | ca. 25 | 26.91 |
| Temperature, ° C. | 175 | 175 | 175 | 175 | 175 | 175 | 175 | 175 | 175 |
| Time, hours | 0.5 | 0.5 | 0.5 | 0.5 | 0.5 | 0.5 | 0.5 | 0.5 | 0.5 |
| Covered Mold | yes | yes | yes | yes | yes | yes | yes | yes | yes |
| Foam | | | | | | | | | |
| Maximum Height, cm | 8.4 | 6.4 | 10.5 | 5.3 | 6 | 7.5 | 8.1 | 10.1 | 8.4 |
| Maximum Diameter, cm | 7.5 | 7.5 | 7.5 | 7.5 | 7.5 | 7.5 | 7.5 | 7.5 | 7.5 |
| Cell Structure | | | | | | | | | |
| uniform | yes | no | no | no | yes | no | yes | no | no |
| average cell size, mm | ca. 1 | <1-2+ | <1-3 | nd | <1 | <1-5 | <1 | 1-3 | <1 |
| Sample Density, kg/m³ | 67.1 | 91.9 | 33.1 | nd | 92.6 | 100 | 42.5 | 63.50 | 48.10 |

1. A phenolic foam composition for forming a phenolic foam, the composition comprising:
a novolac resin;
an oxazolidine hardener; and
a blowing agent.

2. A composition according to claim 1 further comprising a surfactant.

3. A composition according to claim 1 further comprising a nucleating agent.

4. A composition according to claim 1 further comprising one or more of solvents, tougheners, and plasticizers.

5. A composition according to claim 1 wherein the novolac resin is prepared from a phenolic compound and an aldehyde.

6. A composition according to claim 1 that is substantially free of free aldehydes.

7. A composition according to claim 1 that is substantially free of acid catalysts.

8. A composition according to claim 1 wherein the blowing agent is water, fluorocarbons, chlorofluorocarbons, hydrogenated chlorofluorocarbons, linear, branched, or cyclic alkanes, aromatic hydrocarbons, alcohols, fluorinated alcohols, or mixtures of two or more thereof.

9. A phenolic foam comprising the reaction product of the composition of claim 1.

10. A phenolic foam according to claim 9 that is used as an insulating materials for hot or cold pipes, freezers and cold rooms, HVAC equipment, chemical tanks, aircraft, trains, marine applications, roofs, and buildings and mobile homes.

11. A method of manufacturing a phenolic foam, the method comprising:
adding a novolac resin to an extruder;
adding a blowing agent and an oxazolidine hardener to the novolac resin; and
extruding the resulting mix into foam form.
